(19) United States
(12) Patent Application Publication
(10) Pub. No.: US 2011/0117362 A1
(43) Pub. Date: May 19, 2011

(54) PRESSURE-SENSITIVE ADHESIVE TAPE

(76) Inventors: Noboru Yoshida, Osaka (JP); Tatsuya Tsukagoshi, Osaka (JP); Yoshikazu Soeda, Osaka (JP); Yutaka Tosaki, Osaka (JP); Junji Yokoyama, Osaka (JP)

(21) Appl. No.: 12/946,058

(22) Filed: Nov. 15, 2010

(30) Foreign Application Priority Data
Nov. 16, 2009 (JP) 2009-261114

(51) Int. Cl. B32B 27/00

(52) U.S. Cl. 428/336; 428/500; 428/335

(57) ABSTRACT

There is provided a pressure-sensitive adhesive tape that can exhibit good adhesion property and prevent display unevenness, which would otherwise be caused by deformation of the adherend fixed with it, even when exposed to environmental changes such as increases and decreases in temperature. The pressure-sensitive adhesive tape includes a pressure-sensitive adhesive layer comprising a pressure-sensitive adhesive composition containing a (meth)acryl-based polymer that comprises a monomer component of at least an alkyl (meth)acrylate ester having an alkyl group of 4 to 12 carbon atoms, wherein the pressure-sensitive adhesive composition contains 100 parts by weight of the (meth)acryl-based polymer and 5 to 50 parts by weight of a rosin resin, and the pressure-sensitive adhesive layer has a stress-strain curve with a maximum stress of 1.2 to 3.5 N/mm² and a maximum elongation of 700 to 1,300% at 0° C.

### CROSS-REFERENCE TO RELATED APPLICATIONS

This application claims priority to Japanese Patent Application No. 2009-261114, filed Nov. 16, 2009. The aforementioned application is hereby incorporated by reference in its entirety.

### TECHNICAL FIELD

The invention relates to a pressure-sensitive adhesive tape having a pressure-sensitive adhesive layer comprising a pressure-sensitive adhesive composition containing a (meth)acryl-based polymer produced by (co)polymerization of a specific monomer(s).

### BACKGROUND ART

Double-sided pressure-sensitive adhesive tapes can be stamped and processed into any shape before they are bonded to articles, and they are utilized for fixing articles in various industrial fields because of their good workability. In particular, because displays or face plates of portable electronic instruments such as PDAs (Personal Digital Assistance) and cell phones have small and complicated shapes, the double-sided pressure-sensitive adhesive tapes are often used for fixing these small parts.

Recently, portable electronic instruments are required more and more to be thinner due to their manner of utilization, and parts used inside the instruments also have been made thinner. For example, brightness enhancement films and reflector sheets, which are used inside portable electronic instruments, are more likely to have this tendency. These brightness enhancement films and the like are fixed through double-sided pressure-sensitive adhesive sheets or the like.

The portable electronic instruments, which have been made thinner and thinner, cause a problem such as poor impact resistance because of the thinness. In order to solve the problem, Patent Document 1 and Patent Document 2 disclose a method of controlling a loss tangent of a pressure-sensitive adhesive layer forming a double-sided pressure-sensitive adhesive sheet in a specific temperature range; and a method of controlling a loss tangent or a storage modulus of a pressure-sensitive adhesive layer at a specific temperature, whereby pressure-sensitive adhesive sheets having high impact resistance are obtained.

Also, a problem occurs in which adherends such as touch panels deform at high temperature or under high-temperature and high humidity, because transparent plastic substrates used in the touch panels are made thinner. In order to solve this problem, Patent Document 3 attempts to prevent the deformation by laminating a transparent plastic substrate on a double-sided pressure-sensitive adhesive sheet having a pressure-sensitive adhesive layer using an acrylic polymer and an oligomer, whose weight average molecular weights are within specific ranges.
Patent Document 1: JP-A-2005-187513
Patent Document 2: JP-A-2008-231358
Patent Document 3: JP-A-2005-255877

### DISCLOSURE OF THE INVENTION

### Problems to be Solved by the Invention

According to the patent documents listed above, the double-sided pressure-sensitive adhesive sheets have improved impact resistance when a portable electronic instrument is dropped, and improved transparency; however, a problem occurs in which the adherends such as brightness enhancement films, which are fixed on the double-sided pressure-sensitive adhesive sheets, deform when they are exposed to environmental change, such as in a high temperature or low temperature environment.

Thus, an object of the invention is to provide a pressure-sensitive adhesive tape that can exhibit good adhesion property and prevent the adherend (fixed with it) from deformation even under high and low temperature environments so that display unevenness can be prevented.

As a result of investigations to solve the problems, the inventors have made the invention based on the finding that when a pressure-sensitive adhesive tape has a pressure-sensitive adhesive layer comprising a pressure-sensitive adhesive composition containing, as essential components, a specific tackifying resin and a (meth)acryl-based polymer obtained by polymerization of a specific monomer(s) and when the maximum stress and the maximum elongation of the pressure-sensitive adhesive layer are each controlled in a specific range, the pressure-sensitive adhesive tape can exhibit good adhesion property and prevent the adherend (fixed with it) from deformation even under environmental changes such as increases and decreases in temperature.

That is, the pressure-sensitive adhesive tape of the present invention is comprising a pressure-sensitive adhesive layer comprising a pressure-sensitive adhesive composition containing a (meth)acryl-based polymer that comprises a monomer component of at least an alkyl (meth)acrylate ester having an alkyl group of 4 to 12 carbon atoms, the pressure-sensitive adhesive composition containing 100 parts by weight of the (meth)acryl-based polymer and 5 to 50 parts by weight of a rosin resin, the pressure-sensitive adhesive layer having a stress-strain curve with a maximum stress of 1.2 to 3.5 N/mm² and a maximum elongation of 700 to 1,300% at 0° C.

Preferably, in the pressure-sensitive adhesive tape of the present invention, the (meth)acryl-based polymer further comprises a monomer component of an ethylenically unsaturated monomer that has no carboxyl group and is capable of forming a homopolymer with a glass transition temperature of 50 to 190° C.

Preferably, in the pressure-sensitive adhesive tape of the present invention, the ethylenically unsaturated monomer is cyclohexyl methacrylate.

Preferably, in the pressure-sensitive adhesive tape of the present invention, the pressure-sensitive adhesive layer has a gel fraction of 0 to 30% by weight.

The pressure-sensitive adhesive tape of the present invention preferably comprises a substrate, the pressure-sensitive adhesive layer is formed on at least one side of the substrate and has a thickness of 2 μm to 40 μm.

The pressure-sensitive adhesive tape of the present invention is preferably used for fixing a liquid crystal display member for a portable electronic instrument.

Preferably, in the pressure-sensitive adhesive tape of the present invention, the liquid crystal display member is an optical sheet.

The pressure-sensitive adhesive tape of the present invention is preferably used for fixing parts of a portable electronic instrument. The term “portable electronic instrument” herein refers to a portable electronic instrument such as a cell phone or a PDA. Also, the tape can be used in, for example, liquid crystal displays, plasma displays and organic EL displays used in digital cameras, video cameras, car navigation systems, personal computers, televisions and game machines, in addition to the portable electronic instruments described above.

### Effect of the Invention

The pressure-sensitive adhesive tape of the invention produces the advantageous effect that even under environmental changes such as increases and decreases in temperature, it has good adhesion property to the adherend fixed with it, prevents the adherend itself from deformation, and prevents display unevenness which would otherwise be caused by deformation of an optical sheet in cases where the optical sheet is used as the adherend. In particular, the pressure-sensitive adhesive tape of the invention is useful for bonding (fixing) small, complicatedly-shaped parts (e.g., brightness enhancement films, reflector sheets, and polarizing plates) such as display parts and face plates of portable electronic instruments such as PDAs and cellular phones and also suitable for use in fixing parts having a hard-coated bonding surface to plastic parts when it is used in the form of a double-sided pressure-sensitive adhesive tape. Even when bonded to such a member as a brightness enhancement film and exposed to environmental changes such as increases and decreases in temperature, the pressure-sensitive adhesive tape of the invention is also useful to prevent display unevenness which would otherwise be caused by deformation of the brightness enhancement film or the like.

### DETAILED DESCRIPTION OF THE PREFERRED EMBODIMENTS

The present invention will be described in detail in accordance with preferable embodiments.

The pressure-sensitive adhesive tape of the present invention is comprising a pressure-sensitive adhesive layer comprising a pressure-sensitive adhesive composition containing a (meth)acryl-based polymer that comprises a monomer component of at least an alkyl (meth)acrylate ester having an alkyl group of 4 to 12 carbon atoms, the pressure-sensitive adhesive composition containing 100 parts by weight of the (meth)acryl-based polymer and 5 to 50 parts by weight of a rosin resin, the pressure-sensitive adhesive layer having a stress-strain curve with a maximum stress of 1.2 to 3.5 N/mm² and a maximum elongation of 700 to 1,300% at 0° C.

Components for constituting the (meth)acrylic polymer used in the present invention are specifically explained below. The (meth)acrylic acid alkyl ester having an alkyl group with 4 to 12 carbon atoms, which is a main monomer, includes, for example, n-butyl (meth)acrylate, isobutyl (meth)acrylate, sec-butyl (meth)acrylate, t-butyl (meth)acrylate, pentyl (meth)acrylate, isopentyl (meth)acrylate, neopentyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, isononyl (meth)acrylate, decyl (meth)acrylate, isodecyl (meth)acrylate, undecyl (meth)acrylate, and dodecyl (meth)acrylate. These alkyl groups may be either linear or branched. As the (meth)acrylic acid alkyl ester, (meth)acrylic acid alkyl esters having an alkyl group with 4 to 9 carbon atoms are preferable, and n-butyl acrylate, 2-ethylhexyl acrylate, isooctyl acrylate, and isononyl acrylate are more preferable. These (meth)acrylic acid alkyl esters may be used alone or as a mixture of the two or more kinds thereof.

The content of the alkyl (meth)acrylate ester (as a main monomer) in all monomer components used to form the (meth)acryl-based polymer should be 60% by weight or more, preferably from 70 to 95% by weight, more preferably from 80 to 95% by weight. The content is preferably controlled within the above range, so that the pressure-sensitive adhesive tape can provide a desired peel force or a desired cohesive strength.

An ethylenically unsaturated monomer that has no carboxyl group and is capable of forming a homopolymer with a glass transition temperature of 50 to 190° C. may be used. Examples of such an ethylenically unsaturated monomer include, but are not limited to, methyl methacrylate, (meth)acryloyl morpholine, cyclohexyl methacrylate, n-vinylpyrrolidone, isobornyl (meth)acrylate, cyclohexylmaleimide, isopropylmaleimide, and (meth)acrylamide. In particular, cyclohexyl methacrylate is preferred. These monomers may be used singly or in combination of two or more thereof.

The homopolymer formed from the ethylenically unsaturated monomer has a glass transition temperature (Tg) of 50 to 190° C., and preferably 60 to 190° C. When an ethylenically unsaturated monomer whose homopolymer has a Tg of less than 50° C. is used, the desired cohesive force, which is required for pressure-sensitive adhesive tapes, cannot be undesirably obtained, and the deformation cannot be undesirably inhibited. On the other hand, when the Tg is more than 190° C., the desired adhesive property, which is required for pressure-sensitive adhesive tapes, cannot be undesirably obtained.

The content of the ethylenically unsaturated monomer in all monomer components (including the alkyl (meth)acrylate ester as a main monomer) used to form the (meth)acryl-based polymer is preferably from 2 to 8% by weight, more preferably from 2 to 6% by weight, even more preferably from 2 to 4% by weight. If the content of the ethylenically unsaturated monomer is less than 2% by weight, the resulting pressure-sensitive adhesive tape can fail to have the desired cohesive strength and be less likely to have good workability. If the content is more than 8% by weight, it can be difficult to reduce deformation, which is not preferred.

Here, the value of the “glass transition temperature” may be adopted from the value in a catalogue of a monomer manufacture. If there are no catalogue values, the value refers to one obtained by a measurement method described below. That is, to a reactor equipped with a thermometer, a stirrer, a tube for introducing nitrogen and a condenser are added 100 parts by weight of the ethylenically unsaturated monomer, 0.2 parts by weight of azobisisobutyronitrile and 220 parts by weight of ethyl acetate as a polymerization solvent, and the mixture is stirred for one hour while nitrogen gas is introduced thereto. After oxygen is removed from the polymerization system in this manner, the temperature of the system is elevated to 63° C., and the reaction is performed for 8 hours. Then, the temperature is cooled to room temperature to obtain a solution including a homopolymer obtained from the ethylenically unsaturated monomer in a solid concentration of 30% by weight. Then, the polymer solution is cast on a release liner, thereby applying the solution to the liner, and it is dried at 50° C. for 24 hours to produce a test sample (a homopolymer in the state of a sheet) having a thickness of about 2 mm. The test sample is stamped into a disk having a diameter of 7.9 mm, it is sandwiched between parallel plates, and a viscoelasticity is measured, using a viscoelasticity tester (ARES manufactured by Rheometrics Inc.) within a temperature range of −70° C. to 150° C. at a rate of temperature increase of 5° C./minute in a shear mode, while applying a shear strain of a frequency of 1 Hz. A peak-top temperature of a loss modulus G″ is defined as a glass transition temperature.

If necessary, a carboxyl group-containing monomer or a copolymerizable monomer may also be used as a monomer component to form the (meth)acryl-based polymer in combination with the alkyl (meth)acrylate ester and the ethylenically unsaturated monomer.

The carboxyl group-containing monomer includes, for example, (meth)acrylic acid, itaconic acid, crotonic acid, maleic acid, fumaric acid, isocrotonic acid, ω-carboxy-polycaprolactone mono(meth)acrylates (for example, ω-carboxy-polycaprolactone (the average number of repetition, n=2) mono(meth)acrylate, ω-carboxy-polycaprolactone (the average number of repetition, n=3) mono(meth)acrylate, w-carboxy-polycaprolactone (the average number of repetition, n=4) mono(meth)acrylate, etc.); phthalic acid monohydroxyalkyl (meth)acrylates (for example, phthalic acid monohydroxymethyl (meth)acrylate, phthalic acid monohydroxyethyl (meth)acrylate, phthalic acid monohydroxypropyl (meth)acrylate, phthalic acid monohydroxybutyl (meth)acrylate, phthalic acid monohydroxypentyl (meth)acrylate, phthalic acid monohydroxyhexyl (meth)acrylate, phthalic acid monohydroxyheptyl (meth)acrylate, phthalic acid monohydroxyoctyl (meth)acrylate, phthalic acid monohydroxy-2-ethylhexyl (meth)acrylate, phthalic acid monohydroxynonyl (meth)acrylate, phthalic acid monohydroxydecyl (meth)acrylate, phthalic acid monohydroxyundecyl (meth)acrylate, phthalic acid monohydroxydodecyl (meth)acrylate, etc.); succinic acid monohydroxyalkyl (meth)acrylates (for example, succinic acid monohydroxymethyl (meth)acrylate, succinic acid monohydroxyethyl (meth)acrylate, succinic acid monohydroxypropyl (meth)acrylate, succinic acid monohydroxybutyl (meth)acrylate, succinic acid monohydroxypentyl (meth)acrylate, succinic acid monohydroxyhexyl (meth)acrylate, succinic acid monohydroxyheptyl (meth)acrylate, succinic acid monohydroxyoctyl (meth)acrylate, succinic acid monohydroxy-2-ethylhexyl (meth)acrylate, succinic acid monohydroxynonyl (meth)acrylate, succinic acid monohydroxydecyl (meth)acrylate, succinic acid monohydroxyundecyl (meth)acrylate, succinic acid monohydroxydodecyl (meth)acrylate, etc.); acrylic acid dimer; acrylic acid trimer; hexahydrophthalic acid monohydroxyalkyl (meth)acrylates (for example, hexahydrophthalic acid monohydroxymethyl (meth)acrylate, hexahydrophthalic acid monohydroxyethyl (meth)acrylate, hexahydrophthalic acid monohydroxypropyl (meth)acrylate, hexahydrophthalic acid monohydroxybutyl (meth)acrylate, hexahydrophthalic acid monohydroxypentyl (meth)acrylate, hexahydrophthalic acid monohydroxyhexyl (meth)acrylate, hexahydrophthalic acid monohydroxyheptyl (meth)acrylate, hexahydrophthalic acid monohydroxyoctyl (meth)acrylate, hexahydrophthalic acid monohydroxy-2-ethylhexyl(meth)acrylate, hexahydrophthalic acid monohydroxynonyl (meth)acrylate, hexahydrophthalic acid monohydroxydecyl (meth)acrylate, hexahydrophthalic acid monohydroxyundecyl (meth)acrylate, hexahydrophthalic acid monohydroxydodecyl (meth)acrylate, etc.), and the like. They may be used alone or as a mixture of the two or more kinds thereof. Among these, acrylic acid and methacrylic acid are preferable because the adhesive property, which is required for pressure-sensitive adhesive tapes, can be obtained therefrom.

The content of the carboxyl group-containing monomer in all monomer components (including the alkyl (meth)acrylate ester as a main monomer) used to form the (meth)acryl-based polymer is preferably from 2 to 10% by weight, more preferably from 2 to 6% by weight, even more preferably from 2 to 4% by weight. If the content of the carboxyl group-containing monomer is less than 2% by weight, the carboxyl group-containing monomer cannot sufficiently function to form crosslink points in the process of obtaining the (meth)acryl-based polymer, so that the pressure-sensitive adhesive tape may fail to have the desired cohesive strength, which is not preferred. If the content is more than 10% by weight, it may be difficult to reduce deformation, which is not preferred.

In order to control the cohesive force of the (meth)acrylic polymer, examples of the copolymerizable monomer include vinyl ester monomers such as vinyl acetate and vinyl propionate; styrene monomers such as styrene, substituted styrene (α-methyl styrene, etc.), and vinyl toluene; olefin monomers such as ethylene, propylene, isoprene, butadiene, and isobutylene; vinyl chloride, vinylidene chloride; isocyanate group-containing monomers such as 2-(meth)acryloyloxyethyl isocyanate; alkoxy group-containing monomers such as methoxyethyl (meth)acrylate and ethoxyethyl (meth)acrylate; vinyl ether monomers such as methyl vinyl ether and ethyl vinyl ether; and polyfunctional monomers such as 1,6-hexanediol di(meth)acrylate, ethylene glycol di(meth)acrylate, diethylene glycol di(meth)acrylate, triethylene glycol di(meth)acrylate, tetraethylene glycol di(meth)acrylate, (poly)ethylene glycol di(meth)acrylate, propylene glycol di(meth)acrylate, (poly)propylene glycol di(meth)acrylate, neopentyl glycol di(meth)acrylate, pentaerythritol di(meth)acrylate, trimethylol propane tri(meth)acrylate, pentaerythritol tri(meth)acrylate, dipentaerythritol hexa(meth)acrylate, glycerin di(meth)acrylate, epoxyacrylate, polyester acrylate, urethane acrylate, divinyl benzene, butyl di(meth)acrylate, and hexyl di(meth)acrylate, and the like. They may be used alone or as a mixture of the two or more kinds thereof.

The content of the copolymerizable monomer in all monomer components may be appropriately selected from values less than 36% by weight depending on the type of the monomer. To produce good adhesion property, the content is preferably determined so that the resulting (meth)acryl-based polymer can have a glass transition temperature of −40° C. or less, preferably −50° C. or less, more preferably −60° C. or less.

The polymerization method of the monomer (mixture) is not particularly limited, and, for example, a solution polymerization method, a suspension polymerization method, an emulsion polymerization method, or an UV polymerization method may be adopted. Among these, a solution polymerization method is preferable, because of the cost, and because it is not required to use water upon polymerization and therefore the invasion of water to a small article can be prevented when the article is bonded with the pressure-sensitive adhesive tape.

The initiator used in the polymerization reaction includes, for example, azo initiators such as 2,2′-azobisisobutyronitrile (AIBN), 2,2′-azobis(4-methoxy-2,4-dimethyl valeronitrile), 2,2′-azobis(2,4-dimethyl valeronitrile), 2,2′-azobis(2-methylbutylnitrile), 1,1′-azobis(cyclohexane-1-carbonitrile), 2,2′-azobis(2,4,4-trimethylpentane), dimethyl-2,2′-azobis(2-methyl propionate), 2,2′-azobis(2-amidinopropane) dihydrochloride, 2,2′-azobis(N,N′-dimethylene isobutyl amidine) dihydrochloride, 2,2′-azobis[2-(5-methyl-2-imidazolin-2-yl)propane]dihydrochloride, 2,2′-azobis(2-methyl propion amidine) disulfate; peroxides such as benzoyl peroxide, t-butyl hydroperoxide, di-t-butyl hydroperoxide, di-t-butyl peroxide, t-butyl peroxybenzoate, dicumyl peroxide, 1,1-bis(t-butyl peroxy)-3,3,5-trimethyl cyclohexane, and 1,1-bis(t-butyl peroxy)cyclododecane; persulfates such as potassium persulfate and ammonium persulfate, and the like. They may be used alone or as a mixture of the two or more kinds thereof. The initiator may be used in an amount that is usually used in the polymerization reaction described above, and the amount is, for example, from 0.01 to 1 part by weight based on 100 parts by weight of the monomer mixture.

Solvents generally used in a polymerization reaction may be used as the solvent used in the polymerization reaction described above, and include, for example, ethyl acetate, toluene, n-butyl acetate, n-hexane, cyclohexane, methyl ethyl ketone, methyl isobutyl ketone, and the like. They may be used alone or as a mixture of the two or more kinds thereof. The amount of the solvent used may be an amount usually used in the polymerization reaction described above, and it may be, for example from about 50 to 600 parts by weight based on 100 parts by weight of the monomer mixture.

The (meth)acrylic polymer used in the present invention has a weight average molecular weight of preferably 200,000 to 1,000,000, more preferably 400,000 to 800,000. When the molecular weight is within the range described above, the desired cohesive force and adhesive property, which are required for pressure-sensitive adhesive tapes, can be desirably obtained.

The weight average molecular weight of the (meth)acrylic polymer can be controlled through the kind and amount of the polymerization initiator and a chain transfer agent, the temperature and time of the polymerization, the monomer concentration, the dropping rate of the monomers, and the like.

In the present invention, the weight average molecular weight (Mw) of the (meth)acrylic polymer can be measured using a gel permeation chromatograph (GPC). More specifically, using “HLC-8120 GPC” (trade name) manufactured by Tosoh Corporation as a GPC measuring apparatus, it can be found by measurement under the following GPC measurement conditions in terms of polystyrene.

### (GPC Measurement Conditions)

Sample concentration: 0.2% by weight (in a tetrahydrofuran solution)
Amount of sample injected: 10 μl
Eluent: tetrahydrofuran (THF)
Flow volume (flow rate): 0.6 mL/minute
Column temperature (measured temperature): 40° C.
Column: trade name “TSKgelSuper HM-H/H 4000/H 3000/H 2000” manufactured by Tosoh Corporation
Detector: a differential refractive index detector

In an embodiment of the invention, the pressure-sensitive adhesive composition contains a rosin resin as a tackifying resin. The addition of the rosin resin can further improve the adhesion property. The rosin resin is blended in an amount of 5 to 50 parts by weight, preferably 10 to 40 parts by weight, more preferably 15 to 30 parts by weight, based on 100 parts by weight of the (meth)acryl-based polymer. If the rosin resin is blended in an amount of less than 5 parts by weight, the pressure-sensitive adhesive tape can have insufficient adhesion property at the interface with the adherend, so that high adhesive power (adhering strength) can hardly be produced. Also if it is blended in an amount of more than 50 parts by weight, the pressure-sensitive adhesive tape can have insufficient adhesion property (tackiness) at the interface with the adherend, so that high adhesive power (adhering strength) can hardly be produced, which is not preferred.

Examples of the rosin resin include unmodified rosin (raw rosin) such as gum rosin, wood rosin, or tall oil rosin; modified rosin produced by hydrogenation, disproportionation, polymerization, or any other modification of any of these unmodified rosins (such as hydrogenated rosin, disproportionated rosin, polymerized rosin, or any other chemically-modified rosin); and various rosin derivatives. Examples of the rosin derivatives include rosin esters such as rosin ester compounds produced by esterification of unmodified rosins with alcohols and modified rosin ester compounds produced by esterification of modified rosins (such as hydrogenated rosin, disproportionated rosin, and polymerized rosin) with alcohols; unsaturated fatty acid-modified rosins produced by modification of unmodified rosins or modified rosins (such as hydrogenated rosin, disproportionated rosin, and polymerized rosin) with unsaturated fatty acid; unsaturated fatty acid-modified rosin esters produced by modification of rosin esters with unsaturated fatty acid; rosin alcohols produced by reduction of the carboxyl group of unmodified rosins, modified rosins (such as hydrogenated rosin, disproportionated rosin, and polymerized rosin), unsaturated fatty acid-modified rosins, or unsaturated fatty acid-modified rosin esters; and metal salts of rosins such as unmodified rosins, modified rosins, or various rosin derivatives (especially, rosin esters).

The rosin resin preferably has a softening point of 50 to 150° C., and a rosin resin with a softening point of 70 to 140° C. (particularly, glycerin ester of hydrogenated rosin, methyl ester of hydrogenated rosin, glycerin ester of completely hydrogenated rosin, or pentaerythritol of polymerized rosin) may be used. These rosin resins may be used singly or in combination of two or more thereof.

The method for controlling a gel fraction of the pressure-sensitive adhesive layer used in the present invention is not particularly limited, and for example a method in which a cross-linking agent is added to the (meth)acrylic polymer may be exemplified. The cross-linking agent is not particularly limited, and conventionally known ones may be used. Examples thereof include polyfunctional melamine compounds such as methylated methylol melamine and butylated hexamethylol melamine; polyfunctional epoxy compounds such as N,N′,N′-tetraglycidyl m-xylenediamine, diglycidyl aniline, and glycerin diglycidyl ether; polyfunctional isocyanate compounds such as tolylene diisocyanate, hexamethylene diisocyanate, polymethylene polyphenyl isocyanate, diphenylmethane diisocyanate, trimethylolpropane tolylene diisocyanate, polyether polyisocyanate, and polyester polyisocyanate, and the like. In addition, carbodiimide cross-linking agents, aziridine cross-linking agents, and metal chelate cross-linking agents may be also exemplified. They may be used alone or as a mixture of the two or more kinds thereof.

The amount of the cross-linking agent used is usually preferably from 0.001 to 20 parts by weight, more preferably from 0.001 to 10 parts by weight, particularly preferably from 0.01 to 5 parts by weight, based on 100 parts by weight of the (meth)acrylic polymer. When the amount is within the range described above, the desired cohesive force and adhesive property, which are required for pressure-sensitive adhesive tapes (pressure-sensitive adhesives) can be preferably obtained.

In the present invention, the gel fraction refers to a value calculated according to the following “Method for Measuring Gel Fraction”.

### (Method for Measuring Gel Fraction)

First, after the pressure-sensitive adhesive composition (solution) is applied to a release liner, which is dried or cured, and the pressure-sensitive adhesive layer is taken therefrom, or the pressure-sensitive adhesive layer is scraped from the pressure-sensitive adhesive tape. About 0.1 g of the pressure-sensitive adhesive layer is wrapped with a Teflon (registered trademark) sheet (trade name “NTF1122”, manufactured by Nitto Denko Corporation) having a diameter of 0.2 μm, and it is strapped with a kite yarn. The weight thereof is measured, which is defined as a weight before immersion. The weight before immersion is a total weight of the pressure-sensitive adhesive layer, the Teflon sheet, and the kite yarn. The weight of the Teflon sheet and the kite yarn is measured, which is defined as a wrapper weight. Next, the pressure-sensitive adhesive layer wrapped with the Teflon sheet and strapped with the kite yarn is put in a 50 ml-container filled with ethyl acetate, which is allowed to stand at room temperature for one week. After that, the Teflon sheet is taken out from the container, and it is dried in a dryer at 130° C. for two hours to remove ethyl acetate, and then the weight of the sample is measured, which is defined as a weight after immersion. The gel fraction is calculated from the following equation:

Gel fraction (% by weight)=(A−B)/(C−B)×100

wherein A is a weight after immersion, B is a wrapper weight, and C is a weight before immersion.

In the present invention, it is necessary that the gel fraction calculated from the method for measuring the gel fraction described above be from 0 to 30% by weight, preferably from 1 to 30% by weight. When the gel fraction is more than 30% by weight, it is difficult to obtain an adequate cohesive force, and the range is not preferable from the viewpoint of the deformation resistance.

Besides the crosslinking agent, the pressure-sensitive adhesive composition may also contain a general additive such as an ultraviolet-absorbing agent, a light stabilizer, a release-controlling agent, a chain transfer agent, a plasticizer, a softening agent, a filler, a colorant (such as a pigment or a dye), an age resistor, or a surfactant.

In the pressure-sensitive adhesive tape of the invention, the pressure-sensitive adhesive layer has a stress-strain curve with a maximum stress of 1.2 to 3.5 N/mm² and a maximum elongation of 700 to 1,300% at 0° C., preferably has a stress-strain curve with a maximum stress of 1.6 to 2.0 N/mm² and a maximum elongation of 900 to 1,100% at 0° C. If the maximum stress is more than 3.5 N/mm² or the maximum elongation is less than 700%, the amount of deformation of the pressure-sensitive adhesive layer will be too small, so that a member (such as a brightness enhancement film) used with the pressure-sensitive adhesive tape in the interior of a portable electronic instrument can easily peel off, which is not preferred. On the other hand, if the maximum stress is less than 1.2 N/mm² or the maximum elongation is more than 1,300%, the pressure-sensitive adhesive layer will have insufficient cohesive strength, so that a problem such as low workability can occur, which is not preferred.

In the present invention, the maximum stress and the maximum elongation refer to values calculated according to a “Method for Measuring Stress-Strain” below.

### (Method for Measuring Stress-Strain)

A solution of the pressure-sensitive adhesive is cast to a release-treated side of a polyethylene terephthalate film (thickness: 38 μm), thereby applying the solution to the film so that a thickness is about 4 μm after drying, and it is heat-dried at 130° C. for 3 minutes, and then aged at 50° C. for 24 hours, from which a cylindrical sample having a cross-sectional area of 1 mm² is formed. This sample is set on a tension tester (SHIMADZU AUTOGRAPH model AG-IS MS manufactured by Shimadzu Corporation), and a maximum stress (N/mm²) and a maximum elongation (%), generated by pulling the sample at 0° C. under conditions of a distance between chucks of 10 mm and a tensile rate of 300 mm/minute, are measured. The maximum elongation (%) is calculated from a length of the sample before pulling and a length of the sample when the sample is broken by pulling, according to the following equation:

Maximum elongation (%)=100×(a length at break)/(a length of a sample before pulling)

Here, in the present invention, “deformation” refers to a height difference (waviness), which generates on the surface of an adherend (for example, a brightness enhancement film, a reflector sheet, a polarizing plate, etc.), when a pressure-sensitive adhesive tape is evaluated according to Evaluation Method of Deformation Resistance described below.

The pressure-sensitive adhesive tape of the invention (intended to include not only a pressure-sensitive adhesive tape but also a pressure-sensitive adhesive sheet or a pressure-sensitive adhesive film) is useful in various fields of fixing (adhesion) applications. Examples of the pressure-sensitive adhesive tape include a pressure-sensitive adhesive tape (double-sided pressure-sensitive adhesive tape) comprising a single pressure-sensitive adhesive layer (without a substrate), a pressure-sensitive adhesive tape comprising a substrate and a pressure-sensitive adhesive layer provided on one side of the substrate, a double-sided pressure-sensitive adhesive tape comprising a substrate and pressure-sensitive adhesive layers provided on both sides of the substrate, and a product comprising a release film and a single pressure-sensitive adhesive layer provided on the release film.

Methods for forming the pressure-sensitive adhesive tape of the present invention are not particularly limited, and known methods may be employed. For example, a method in which a pressure-sensitive adhesive composition solution is applied to a substrate in a suitable spreading method such as a flow casting method or a coating method, and dried; a method in which a pressure-sensitive adhesive layer is transferred using a release sheet on which the layer is provided, and the like are exemplified. As the applying methods, roll coating methods such as reverse coating and gravure coating, spin coating methods, screen coating methods, fountain coating methods, dipping methods and spray methods can be employed. When the pressure-sensitive adhesive solution is applied and then the solvent is volatilized in a drying step, a pressure-sensitive adhesive layer having a predetermined thickness can be obtained.

The thickness of the pressure-sensitive adhesive layer is preferably, but not limited to, from 2 to 40 μm, more preferably from 4 to 20 μm. If the thickness of the pressure-sensitive adhesive layer is less than 2 μm, sufficient adhesive power can be difficult to obtain. On the other hand, if it is more than 40 μm, the pressure-sensitive adhesive tape may tend to have low workability so that a trouble such as squeezing out of the adhesive or a stamping failure may easily occur in the process of stamping the tape into the shape desired for fixation of a small article.

Any substrate may be used without particular limitation, so long as it is generally used in the field of pressure-sensitive adhesive tapes, and examples thereof may include plastics (cellophane, polyethylene, polypropylene, polyester, polyvinyl chloride, acetate, polystyrene, polyacrylonitrile, polyethylene terephthalate, laminates thereof, etc.); rubber sheets; papers (Japanese paper, kraft paper, etc.); fabrics (cotton, staple fiber, chemical fiber, unwoven fabric, etc.); metal foil, and the like. Also, films or foams composed of a polymer having an elastic property may be used. In addition, substrates which have been subjected to a known treatment such as under-coating treatment, filling treatment, corona treatment or back face treatment may be used.

The thickness of the substrate is not particularly limited, and suitably selected depending on the kind of the substrate or the use. It is usually from about 5 to 500%.

### EXAMPLES

The present invention is described in more detail by means of Examples, but it is not limited thereto. In the following, part is “part by weight,” unless otherwise indicated.

### (Production of (Meth)acrylic Polymer (a))

To a reactor equipped with a thermometer, a stirrer, a tube for introducing nitrogen, and a condenser were added 92 parts of 2-ethylhexyl acrylate (2EHA), 4 parts of cyclohexyl methacrylate (CHMA), and 4 parts of acrylic acid (AA) as monomer components and 120 parts of ethyl acetate as a polymerization solvent, and the mixture was stirred for one hour, while nitrogen was introduced thereto, whereby the inside of the polymerization system was substituted with nitrogen. After that, the temperature of the system was elevated to 63° C., and then 0.3 parts of 2,2′-azobisisobutyronitrile (AIBN) dissolved in 3 parts of ethyl acetate was added, which was reacted at that temperature for 8 hours to obtain a (meth)acrylic polymer (a) having a weight average molecular weight of 570,000.

### (Resin A)

Resin A used was a hydrogenated rosin glycerin ester resin (Rikatack SE10 (trade name) with a softening point of 75° C. manufactured by Rika Fine-Tech Inc.).

### (Resin B)

Resin B used was a polymerized rosin pentaerythritol ester resin (Rikatack PCJ (trade name) with a softening point of 128° C. manufactured by Rika Fine-Tech Inc.).

### (Resin C)

Resin C used was a cycloaliphatic saturated hydrocarbon resin (hydrogenated alicyclic petroleum resin) (ALKON P-140 (trade name) with a softening point of 140° C. manufactured by Arakawa Chemical Industries, Ltd.).

### (Resin D)

Resin D used was a hydrogenated aliphatic petroleum resin (Quintone A100 (trade name) with a softening point of 100° C. manufactured by ZEON CORPORATION).

### Example 1

To 100 parts (solid basis) of the (meth)acryl-based polymer (a) were added 0.015 parts of a tetrafunctional epoxy crosslinking agent (TETRAD-C (trade name) manufactured by MITSUBISHI GAS CHEMICAL COMPANY, INC.), 1 part of an isocyanate crosslinking agent (Coronate L (trade name) manufactured by Nippon Polyurethane Industry Co., Ltd.), and 30 parts of the resin A to form a pressure-sensitive adhesive composition solution. The solution was applied to the release-treated surface of a polyethylene terephthalate film (release liner 38 μm in thickness) by casting so that a coating with a thickness of 4 μm could be formed after drying. The coating was dried by heating at 130° C. for 3 minutes to form a pressure-sensitive adhesive layer. Two pieces of this product were prepared and then bonded to both sides of a polyethylene terephthalate film (substrate 22 μm in thickness) and aged at 50° C. for 24 hours to form a double-sided pressure-sensitive adhesive tape, which had the substrate and the pressure-sensitive adhesive layers provided on both sides of the substrate.

### Example 2

A double-sided pressure-sensitive adhesive tape was prepared using the process of Example 1, except that the tetrafunctional epoxy crosslinking agent (TETRAD-C (trade name) manufactured by MITSUBISHI GAS CHEMICAL COMPANY, INC.) was used in an amount of 0.01 parts.

### Example 3

A double-sided pressure-sensitive adhesive tape was prepared using the process of Example 1, except that the tetrafunctional epoxy crosslinking agent (TETRAD-C (trade name) manufactured by MITSUBISHI GAS CHEMICAL COMPANY, INC.) was used in an amount of 0.01 parts and that 30 parts of the resin B was added in place of the resin A.

### Comparative Example 1

A double-sided pressure-sensitive adhesive tape was prepared using the process of Example 1, except that the tetrafunctional epoxy crosslinking agent (TETRAD-C (trade name) manufactured by MITSUBISHI GAS CHEMICAL COMPANY, INC.) was used in an amount of 0.03 parts.

### Comparative Example 2

A double-sided pressure-sensitive adhesive tape was prepared using the process of Example 1, except that the tetrafunctional epoxy crosslinking agent (TETRAD-C (trade name) manufactured by MITSUBISHI GAS CHEMICAL COMPANY, INC.) was used in an amount of 0.01 parts and that 30 parts of the resin C was added in place of the resin A.

### Comparative Example 3

A double-sided pressure-sensitive adhesive tape was prepared using the process of Example 1, except that the tetrafunctional epoxy crosslinking agent (TETRAD-C (trade name) manufactured by MITSUBISHI GAS CHEMICAL COMPANY, INC.) was used in an amount of 0.01 parts and that 30 parts of the resin D was added in place of the resin A.

The formulations in the examples and the comparative examples and the evaluation results are shown in Table 1.

Method for Evaluating Deformation Resistance

One side of a glass plate (MICRO SLIDE GLASS S200423 (trade name) 65 mm×165 mm in size, 1.2-1.5 mm in thickness, manufactured by Matsunami Glass Ind, Ltd.) was bonded to a polarizing plate with the same area (a polarizing plate manufactured by NITTO DENKO CORPORATION, which has a surface layer of TAC film (TD80UL (trade name) manufactured by FUJIFILM Corporation)).

The pressure-sensitive adhesive tape obtained in each of the examples and the comparative examples was stamped into a frame shape with an outer circumference size of 39.6 mm×52.8 mm, an inner circumference size of 35.6 mm×48.8 mm, and a width of 2 mm.

One side of the frame-shaped double-sided pressure-sensitive adhesive tape formed by stamping was bonded to the surface of the polarizing plate, and the other pressure-sensitive adhesive side was bonded to a brightness enhancement film (TBEF2-T-I140 (trade name) manufactured by 3M, 37.6 mm×50.8 mm in size, 0.062 mm in thickness), so that a sample was obtained. In this process, the double-sided pressure-sensitive adhesive tape and the brightness enhancement film were bonded in a width of 1 mm. Two samples were prepared each of which was a laminate of one piece of the glass plate and the polarizing plate, the frame-shaped double-sided pressure-sensitive adhesive tape, and the brightness enhancement film stacked in this order on the glass plate.

The samples were subjected to 100 heating-cooling cycles (heating at 80° C. for 1 hour and cooling at −30° C. for 1 hour per cycle) and then visually evaluated for the degree of the deformation. As a result of the evaluation, the non-deformation sample was expressed by the mark “◯” and the deformation sample was expressed by the mark “x.” When light is applied to the backside of the brightness enhancement film, the deformation sample produces display light leakage and therefore is identified visually. Such a deformation pressure-sensitive adhesive tape is not preferred, because when used in a portable electronic instrument or the like, it is more likely to cause a defect such as brightness unevenness.

TABLE 1

| Formulation | | | | Comparative | | |
|---|---|---|---|---|---|---|
| and evaluation | Examples | | | Examples | | |
| result | 1 | 2 | 3 | 1 | 2 | 3 |
| Resin | A | A | B | A | C | D |
| Resin amount | 15 | 30 | 30 | 30 | 30 | 30 |
| (parts) | | | | | | |
| Epoxy | 0.01 | 0.01 | 0.01 | 0.03 | 0.01 | 0.01 |
| crosslinking | | | | | | |
| agent (parts) | | | | | | |
| Isocyanate | 1 | 1 | 1 | 1 | 1 | 1 |
| crosslinking | | | | | | |
| agent (parts) | | | | | | |
| Gel fraction | 6 | 5 | 5 | 40 | 12 | 12 |
| (% by weight) | | | | | | |
| Maximum | 1.4 | 1.6 | 3.0 | 4.0 | 1.7 | 1.7 |
| stress (N/mm²) | | | | | | |
| Maximum | 930 | 960 | 900 | 600 | 900 | 900 |
| elongation (%) | | | | | | |
| Deformation | ∘ | ∘ | ∘ | x | x | x |
| resistance | | | | | | |

As is evident from the results in Table 1, it has been demonstrated that the pressure-sensitive adhesive tape of each of Examples 1 to 3 has the maximum stress and the maximum elongation each falling within the desired range and therefore has high deformation resistance, because it has a pressure-sensitive adhesive layer produced with a pressure-sensitive adhesive composition containing specified amounts of a rosin resin as a tackifying resin and a (meth)acryl-based polymer produced by polymerization of the specific (meth)acrylate monomer. In Comparative Example 1, however, the gel fraction is high so that the maximum stress or the maximum elongation does not fall within the desired range, which makes it impossible to regulate the deformation resistance, and in Comparative Examples 2 and 3, deformation resistance cannot be obtained, because the specified amount of the rosin resin is not added.

1. A pressure-sensitive adhesive tape, comprising a pressure-sensitive adhesive layer comprising a pressure-sensitive adhesive composition containing a (meth)acryl-based polymer that comprises a monomer component of at least an alkyl (meth)acrylate ester having an alkyl group of 4 to 12 carbon atoms,
the pressure-sensitive adhesive composition containing 100 parts by weight of the (meth)acryl-based polymer and 5 to 50 parts by weight of a rosin resin,
the pressure-sensitive adhesive layer having a stress-strain curve with a maximum stress of 1.2 to 3.5 N/mm² and a maximum elongation of 700 to 1,300% at 0° C.

2. The pressure-sensitive adhesive tape according to claim 1, wherein the (meth)acryl-based polymer further comprises a monomer component of an ethylenically unsaturated monomer that has no carboxyl group and is capable of forming a homopolymer with a glass transition temperature of 50 to 190° C.

3. The pressure-sensitive adhesive tape according to claim 2, wherein the ethylenically unsaturated monomer is cyclohexyl methacrylate.

4. The pressure-sensitive adhesive tape according to claim 1, wherein the pressure-sensitive adhesive layer has a gel fraction of 0 to 30% by weight.

5. The pressure-sensitive adhesive tape according to claim 1, further comprising a substrate, wherein the pressure-sensitive adhesive layer is formed on at least one side of the substrate and has a thickness of 2 μm to 40 μm.

6. The pressure-sensitive adhesive tape according to claim 1, which is for use in fixing a liquid crystal display member for a portable electronic instrument.

7. The pressure-sensitive adhesive tape according to claim 6, wherein the liquid crystal display member is an optical sheet.

8. The pressure-sensitive adhesive tape according to claim 2, wherein the pressure-sensitive adhesive layer has a gel fraction of 0 to 30% by weight.

9. The pressure-sensitive adhesive tape according to claim 3, wherein the pressure-sensitive adhesive layer has a gel fraction of 0 to 30% by weight.

10. The pressure-sensitive adhesive tape according to claim 1, wherein the content of the alkyl (meth)acrylate ester monomer component of the (meth)acryl-based polymer is 60% by weight or more.

11. The pressure-sensitive adhesive tape according to claim 2, wherein the content of the ethylenically unsaturated monomer component of the (meth)acryl-based polymer is 2 to 8% by weight.

12. The pressure-sensitive adhesive tape according to claim 1, wherein the (meth)acryl-based polymer further comprises a carboxyl group-containing monomer component, and wherein the content of the carboxyl group-containing monomer component of the (meth)acryl-based polymer is 2 to 10% by weight.

13. The pressure-sensitive adhesive tape according to claim 1, wherein the (meth)acrylic polymer has a weight average molecular weight of 200,000 to 1,000,000.

14. The pressure-sensitive adhesive tape according to claim 1, wherein the rosin resin has a softening point of 50 to 150° C.
